(19) United States
(12) Patent Application Publication
(10) Pub. No.: US 2007/0134988 A1
(43) Pub. Date: Jun. 14, 2007

(54) INFORMATION PROCESSING APPARATUS IN WHICH MEMORY CARDS OF DIFFERENT SIZES CAN BE USED

(76) Inventor: Takafumi Ito, Ome-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/567,993

(22) Filed: Dec. 7, 2006

(30) Foreign Application Priority Data
Dec. 9, 2005 (JP) 2005-356949

(51) Int. Cl. H01R 24/00

(52) U.S. Cl. 439/630

(57) ABSTRACT

An information processing apparatus includes a card slot into which a nonvolatile memory card is inserted, and a device driver software having a function which accesses the nonvolatile memory card inserted into the card slot. Upon determining that the nonvolatile memory card needs to be initialized, the device driver software initializes the nonvolatile memory card and generates state information indicating that the nonvolatile memory card has been newly inserted.

### CROSS-REFERENCE TO RELATED APPLICATIONS

This application is based upon and claims the benefit of priority from prior Japanese Patent Application No. 2005-356949, filed Dec. 9, 2005, the entire contents of which are incorporated herein by reference.

### BACKGROUND OF THE INVENTION

1. Field of the Invention

The present invention relates to an information processing apparatus. More specifically, the present invention relates to a SD (Secure Digital/trade mark) card processing apparatus in which miniSD cards and microSD cards can be used.

2. Description of the Related Art

In recent years, semiconductor memory cards such as SD cards, miniSD cards, and microSD cards have been put to practical use as portable media. In spite of a difference in size among them, these media are all nonvolatile card type memories to which data can be rewritten.

When a miniSD card or a microSD card is used in a personal computer, an SD card adapter is normally used. In this case, the miniSD card or microSD card is installed in the SD card adapter, which is wholly inserted into a card slot for SD cards in the personal computer. Alternatively, the SD card adaptor containing the miniSD card or microSD card is inserted into a card slot in an SD card reader/writer connected to the personal computer via a serial interface such as USB (Universal Serial Bus). This enables the miniSD card and microSD card to be used in the personal computer.

Personal computers comprising a card slot for SD cards have been spreading widely. However, most general-purpose personal computers do not comprise a card slot for miniSD cards and microSD cards. Thus, the SD card adapter is provided to enable miniSD cards and microSD cards to be used in personal computers comprising no card slot for miniSD cards and microSD cards. Of course, even the personal computer comprising no card slot for miniSD cards and microSD cards uses the SD card adapter to enable miniSD cards and microSD cards to be used via a reader/writer. The SD card adapter converts the shape of terminals of a miniSD card or microSD card directly into the shape of terminals of the SD card and has no active electric circuit.

Personal computers comprising a card slot for SD cards and SD host equipment (SD card processing apparatuses) such as SD card reader/writers have a mechanical switch (SD card detection switch) that detects that an SD card has been inserted into the card slot. That is, an SD host controller inside the SD host equipment detects that the SD card has been removed and inserted on the basis of an output from the SD card detection switch. For miniSD cards and microSD cards, the SD card detection switch can detect removal and insertion of the card when the whole SD card adaptor is removed and inserted.

More specifically, when removal or insertion of the SD card is detected on the basis of an output from the SD card detection switch, the SD host equipment internally generates a status indicating “Media Changed”. Software in the SD host equipment checks the status to recognize that the media (SD card) has been changed. Further, upon detecting removal and insertion of the SD card, the SD host equipment loads file management information from the SD card before writing file data to the SD card. The file management information is, for example, data stored in a FAT (File Allocation Table for file management) and data in a directory entry (area in which file names, file sizes, file directories, and the like are stored). Consequently, even if the SD card is changed, the file data (file format) in the newly installed SD card (which has replaced the original media) is prevented from being inconsistent.

Similarly, the SD card adaptor is removed and then installed to change the miniSD card or microSD card, the software can recognize the change of the miniSD card or microSD card by checking the status “Media Changed”. Thus, in writing file data to the miniSD card or microSD card, the file data in the newly installed miniSD card or microSD card is prevented from being inconsistent.

However, if the miniSD card or microSD card is removed from the SD card adaptor remaining inserted in the card slot, the SD card detection switch is not activated. Thus, in spite of change of the media to another miniSD card or microSD card, the SD host equipment cannot detect the removal and insertion of the miniSD card and microSD card. In this case, when the SD host equipment accesses the newly installed miniSD card or microSD, the following problem may occur.

In short, when the miniSD card or microSD card is changed, file management information in the original miniSD card or microSD card has been loaded in RAM (Random Access Memory) in the SD host equipment. Thus, the file data is loaded from the newly installed miniSD card or microSD card in accordance with the file management information in the original miniSD card or microSD card loaded in RAM. Consequently, the correct file data cannot be loaded from the newly installed miniSD card or microSD card.

For writing of the file data, the file data is written to the newly installed miniSD card or microSD card in accordance with the file management information in the original miniSD card or microSD card already loaded in RAM. This prevents the correct file data from being written to the newly installed miniSD card or microSD card. Further, the file management information is updated simultaneously with writing of the file data, but the updated file management information relates to the original miniSD card or microSD card. Thus, the file management information is inconsistent with the file data, preventing proper accesses to the file data in the newly installed miniSD card or microSD card.

This problem has been avoided through instruction manuals or the like which warn that when the miniSD card or microSD card is removed from the SD host equipment, the whole SD card adaptor should be removed. However, in this case, the user's carelessness may cause such problems as described above.

As prior techniques relating to the present invention, various related techniques have been proposed (see, for example, Jpn. Pat. Appln. KOKAI Publication No. 2004-133881).

### BRIEF SUMMARY OF THE INVENTION

According to a first aspect of the present invention, there is provided an information processing apparatus comprising a card slot into which a nonvolatile memory card is inserted; and a device driver software having a function which accesses the nonvolatile memory card inserted into the card slot, device driver software, upon determining that the nonvolatile memory card needs to be initialized, initializing the nonvolatile memory card and generating state information indicating that the nonvolatile memory card has been newly inserted.

According to a second aspect of the present invention, there is provided an information processing apparatus comprising a card slot into which a nonvolatile memory card is inserted; a detection switch which detects insertion of the nonvolatile memory card into the card slot; software which recognizes that the nonvolatile memory card has been newly inserted on the basis of state information corresponding to an output from the detection switch; and a driver having a function which accesses the nonvolatile memory card inserted into the card slot, the driver generating the state information on the basis of the output from the detection switch; wherein if the driver accesses the nonvolatile memory card to determine that the nonvolatile memory card needs to be initialized, the driver initializes the nonvolatile memory card.

According to a third aspect of the present invention, there is provided a card reader/writer comprising a card slot into which a nonvolatile memory card is inserted; and a controller having a function which accesses the nonvolatile memory card inserted into the card slot, wherein if the controller determines that the nonvolatile memory card needs to be initialized, the card reader/writer initializes the nonvolatile memory card, generates state information indicating that the nonvolatile memory card has been newly inserted, and notifies an information processing apparatus connected to the card reader/writer of the state information.

### BRIEF DESCRIPTION OF THE SEVERAL VIEWS OF THE DRAWING

FIG. 1 is a diagram of a configuration of an information processing apparatus according to a first embodiment of the present invention showing a personal computer having an SD card slot, as an example;

FIG. 2 is a diagram showing a software structure in the information processing apparatus shown in FIG. 1;

FIG. 3 is a flowchart illustrating how an SD card driver operates during a file access in the information processing apparatus shown in FIG. 1;

FIG. 4 is a diagram of a configuration of an information processing apparatus according to a second embodiment of the present invention showing a card reader/writer connected to a personal computer, as an example;

FIG. 5 is a diagram showing a software structure in the system shown in FIG. 4; and

FIG. 6 is a flowchart illustrating how firmware operates during a file access in the system shown in FIG. 4.

### DETAILED DESCRIPTION OF THE INVENTION

Embodiments of the present invention will be described with reference to the accompanying drawings. It should be noted that the drawings are schematic ones and the dimension ratios shown therein are different from the actual ones. The dimensions vary from drawing to drawing and so do the ratios of dimensions. The following embodiments are directed to a device and a method for embodying the technical concept of the present invention and the technical concept does not specify the material, shape, structure or configuration of components of the present invention. Various changes and modifications can be made to the technical concept without departing from the scope of the claimed invention.

### First Embodiment

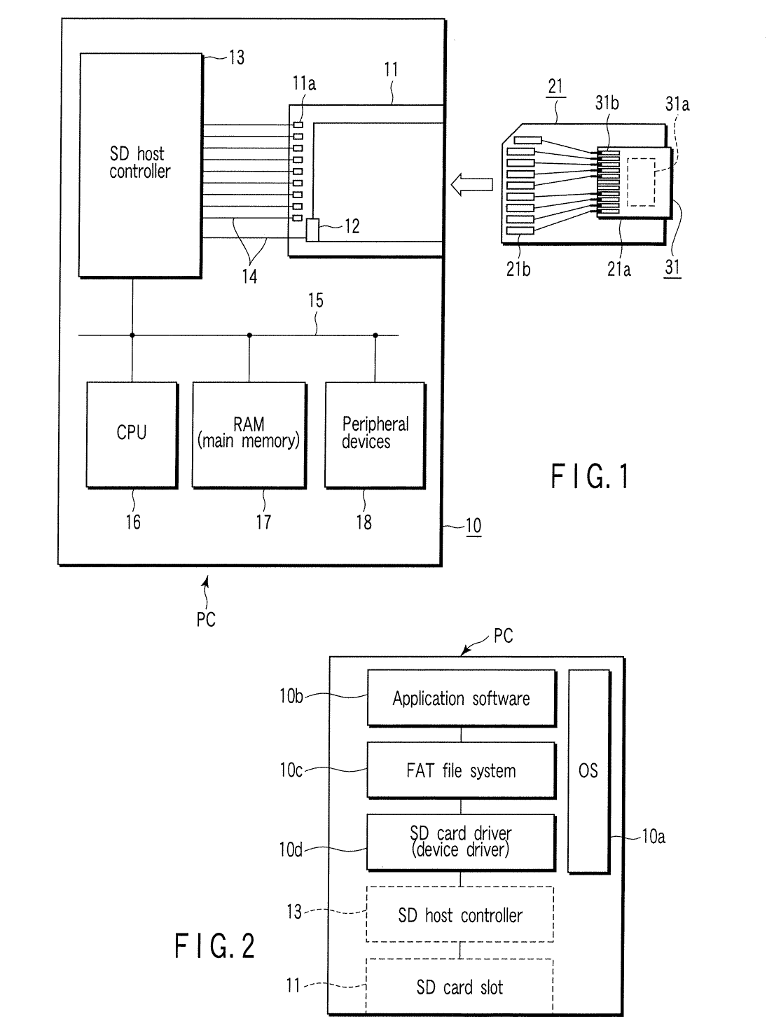

FIG. 1 shows the basic configuration of a personal computer (SD host equipment) having an SD card slot, which serves as an information processing apparatus (SD card processing apparatus) according to a first embodiment of the present invention. For convenience, FIG. 1 shows only essential parts required for the configuration of the present embodiment.

As shown in FIG. 1, an SD card slot (SD connector) 11 is formed in a housing (main body) 10 of a personal computer PC. An SD card (not shown) that is a second nonvolatile semiconductor memory card or an SD card adaptor 21 is inserted directly into the SD card slot 11. A media (first nonvolatile semiconductor memory card) 31 such as a miniSD card or a microSD card is inserted into the SD card slot 11 via the SD card adaptor 21. That is, the miniSD card or microSD card (media 31) is installed in the SD card adaptor 21, which is then wholly inserted into the SD card slot 11.

Here, the miniSD card or microSD card, the media 31, internally has a semiconductor memory chip 31a and externally has a plurality of external connection electrodes 31b. The miniSD card and microSD card each have a size different from that of the SD card but are both nonvolatile card type memories to which data can be rewritten.

In contrast, the SD card adaptor 21 has the same interface as that of the SD card. For example, the SD card adaptor 21 is formed to have the same shape (same size) as that of the SD card. The SD card adaptor 21 also has a housing section 21a in which the installed media 31 is housed and a plurality of connection terminals 21b that connect to the plurality of external connection electrodes 31b exposed from the housed media 31. The plurality of connection terminals 21b simply covert the shape of terminals (external connection electrodes 31b) of the media 31 into the one conforming to SD card specifications (shape of terminals of the SD card). That is, the SD card adaptor 21 has no active electric circuit and enables an SD card driver to access the installed media 31 via the plurality of connection terminals 21b for terminal shape conversion. This makes it possible to use the miniSD card and microSD card in a personal computer PC having no card slot dedicated to the miniSD card and microSD card.

A card detection switch 12 is provided in the SD card slot 11. The card detection switch 12 mechanically detects that the SD card or the SD card adaptor 21 has been inserted into the SD card slot 11. A plurality of connection electrodes 11a are also provided in the SD card slot 11. The plurality of connection electrodes 11a are connected to the eternal connection electrodes of the SD card or to the plurality of connection electrodes 21b of the SD card adaptor 21.

An SD host controller 13 is provided in the housing 10 of the personal computer PC. The card detection switch 12, provided in the SD card slot 11, and the plurality of connection electrodes 11a are connected to the SD host controller 13 via an SD bus 14. Central processing unit (CPU) 16, RAM (main memory) 17, peripheral devices 18, and the like are connected to the SD host controller 13 via a system bus 15.

FIG. 2 shows a software structure in the personal computer PC configured as shown in FIG. 1. As shown in FIG. 2, the personal computer PC is provided not only with operating system (OS) 10a but also with application software 10b, a FAT file system 10c, an SD card driver (device driver) 10d, and the like. In the present embodiment, the application software 10b is the top-level software, followed by the FAT file system 10c, followed by the SD card driver 10d. The SD host controller 13 is connected to the SD card driver 10d. The SD card slot 11 (that is, the card detection switch 12 and the plurality of connection electrodes 11a) is connected to the SD host controller 13.

Now, with reference to FIG. 2, description will be given of file access of the application software 10b to the media (miniSD card or microSD card) 31.

First, the miniSD card or microSD card is installed in the SD card adaptor 21. The SD card adaptor 21 containing the miniSD card or microSD card is inserted into the SD card slot 11. Then, the card detection switch 12 detects the insertion of the SD card or the SD card adaptor 21. This information is transmitted from the SD host controller 13 to the FAT file system 10c via the SD card driver 10d. In this case, a status (state information) indicating “Media Changed” is internally generated. The application software 10b checks the status to recognize that the media 31 has been changed.

The application software 10b subsequently gives an instruction for a file access. The FAT file system 10c thus controls the SD card driver 10d so that file management information is loaded from the miniSD card or microSD card. That is, the SD card driver 10d accesses the miniSD card or microSD card to read, for example, data from an FAT area or a directory entry to obtain file management information. The SD host controller 13 stores the read file management information in RAM 17 via the system 15. In addition to acquiring the file management information, a predetermined initialization process (described later in detail) is executed when, for example, the media is changed after power-on.

In this state, it is assumed that the application software 10 gives an instruction for a file access to the FAT file system 10c. The FAT file system 10c then references the file management information stored in RAM 17 to allow the SD card driver 10d to execute a file access on the miniSD card or microSD card.

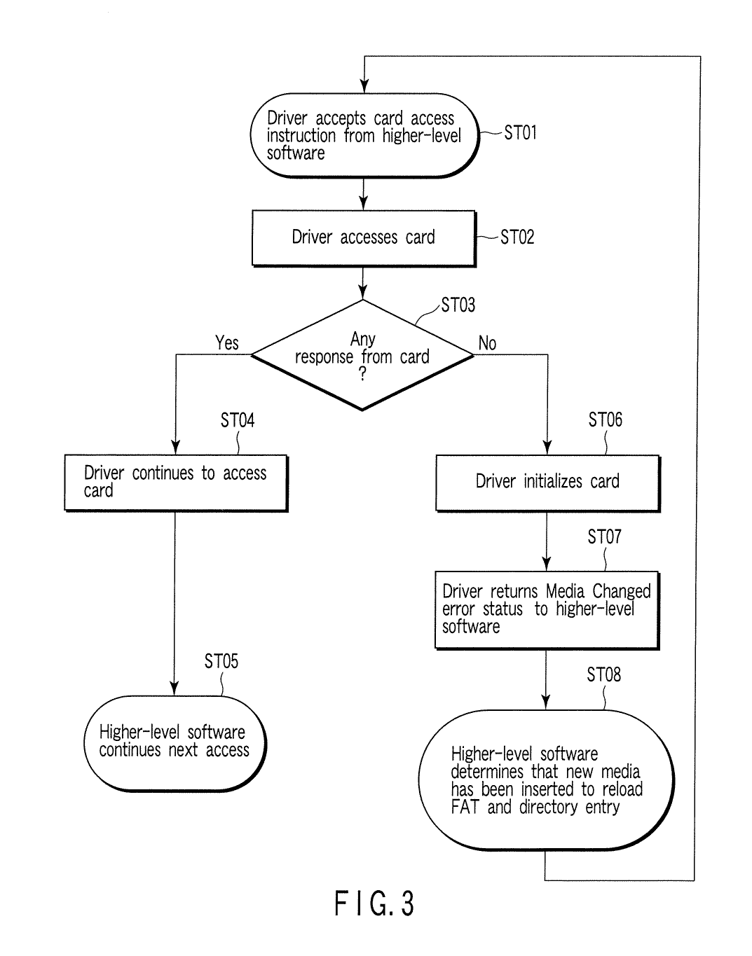

FIG. 3 shows the operation (process flow) of the SD card driver during a file access to the miniSD card or microSD card. It is assumed that the SD card driver 10d accepts an instruction for a file access from the application software via the FAT file system 10c (step ST01). The SD card driver 10d then issues an access command to the miniSD card or microSD card via the SD host controller 13 (step ST02).

If the miniSD card or microSD card has not been changed, a normal response to the access command is returned by the miniSD card or microSD card (step ST03). The normal response is also returned when the SD card or the SD card adaptor 21 has been regularly removed and inserted. Thus, upon receiving the normal response, the SD card driver 10d continues the access process on the miniSD card or microSD card (step ST4). The application software 10b is subsequently notified of end of the access process (step ST05). The application software 10b then enters a standby state to get ready to give an instruction for the next file access.

In step ST03, if the SD card driver 10d does not receive the normal response from the miniSD card or microSD card, it determines that the miniSD card or microSD card needs to be initialized. The SD card driver 10d thus performs a predetermined initialization process (step ST06). This initialization process is initial processing enabling accesses to the card, for example, setting of parameters for determining a bus interface.

If the miniSD card or microSD card is removed and inserted with the SD card adaptor 21 remaining inserted in the SD card slot 11, the card detection switch 12 is not activated. Thus, the newly installed miniSD card or microSD card has not been subjected to the initialization process otherwise executed after power-on (when the media is changed). Consequently, the miniSD card or microSD card does not return the normal response to the access command from the SD host controller 13. Thus, the SD card driver 10d forcibly performs the initialization process on the miniSD card or microSD card that does not make the normal response so that the SD card driver 10 can access the miniSD card or microSD card.

The SD card driver 10d also returns the status (state information) “Media Changed”, indicating that the media 31 has been changed, to the higher-level FAT file system 10c and application software 10b (step ST07). This enables the application software 10b to recognize that the miniSD card or microSD card has been changed even though the card detection switch 12 is not activated. The SD card driver 10d further accesses the newly installed miniSD card or microSD card in accordance with an instruction from the FAT file system 10c to read, for example, data from the FAT area and directory entry to obtain file management information. The SD host controller 13 then stores the read file management information in RAM 17 via the system bus 15 (step ST08).

It is assumed that the SD card driver 10d subsequently accepts an instruction for a file access from the application software 10d via the FAT file system 10c again (step ST01). Then, in steps ST2, ST03, and ST04, on the basis of the file management information re-stored in RAM 17, the SD card driver 10d executes a file access process on the newly installed miniSD card or microSD card.

As described above, even if the user carelessly removes only the miniSD card or microSD card with the SD card adaptor 21 remaining in the SD card slot 11 and changes it to another media 31, the file data (file format) in the newly inserted media 31 can be prevented from being inconsistent. That is, upon determining that the media 31 be initialized on the basis of a response from the miniSD card or microSD card as a result of an access to the card, the SD card driver 10d initializes the miniSD card or microSD card. At the same time, the SD card driver 10s returns a status indicating that the media 31 has been changed, to the FAT file system 10c and application software 10b. This enables the file management information in the newly installed media 31 to be reloaded so that the newly installed media 31 can be properly accessed. Therefore, the convenience of the miniSD card and microSD card can be improved, for example, the newly installed media 31 can be properly accessed in spite of a failure to detect the change of the media 31.

### Second Embodiment

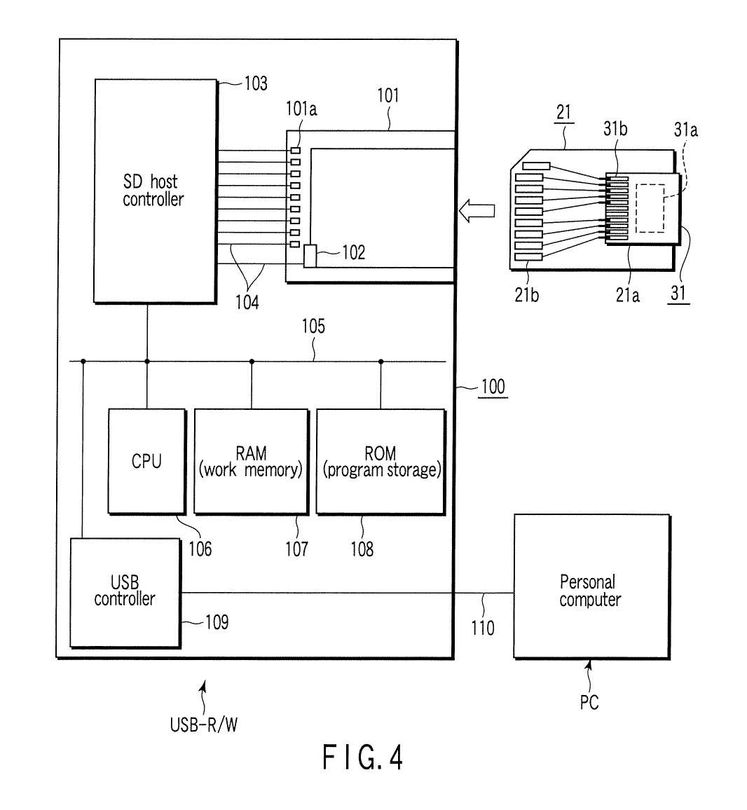

FIG. 4 shows the basic configuration of an SD card reader/writer (SD host equipment) USB-connected to the personal computer, which serves as an information processing apparatus (SD card processing apparatus) according to a second embodiment of the present invention. For convenience, FIG. 4 shows only essential parts required for the configuration of the present embodiment. The same components as those in FIG. 1 are denoted by the same reference numerals and their detailed description is omitted.

As shown in FIG. 4, an SD card slot (SD connector) 101 is formed in a housing (main body) 100 of an SD card reader/writer USB-R/W. The SD card (not shown) that is a second nonvolatile semiconductor memory card or the SD card adaptor 21 is inserted directly into the SD card slot 101. The media (first nonvolatile semiconductor memory card) 31 such as the miniSD card or microSD card is inserted into the SD card slot 101 via the SD card adaptor 21. That is, the miniSD card or microSD card (media 31) is installed in the SD card adaptor 21, which is then wholly inserted into the SD card slot 101.

A card detection switch 102 is provided in the SD card slot 101. The card detection switch 102 mechanically detects that the SD card or the SD card adaptor 21 has been inserted into the SD card slot 101. A plurality of connection electrodes 101a are also provided in the SD card slot 101. The plurality of connection electrodes 101a are connected to the eternal connection electrodes of the SD card or to the plurality of connection electrodes 21b of the SD card adaptor 21.

An SD host controller 103 is provided in the housing 100 of the SD card reader/writer USB-R/W. The card detection switch 102, provided in the SD card slot 101, and the plurality of connection electrodes 101a are connected to the SD host controller 103 via an SD bus 104. CPU (Central Processing Unit) 106, RAM (work memory) 107, ROM (Read Only Memory) 108 in which programs are stored, a USB controller 109, and the like are connected to the SD host controller 103 via a system bus 105. A personal computer PC such as the one shown in FIG. 1 is connected to the USB controller 109 via USB 110. This makes it possible to use the miniSD card and microSD card (or SD card) in a personal computer PC having no card slot dedicated to the miniSD card and microSD card.

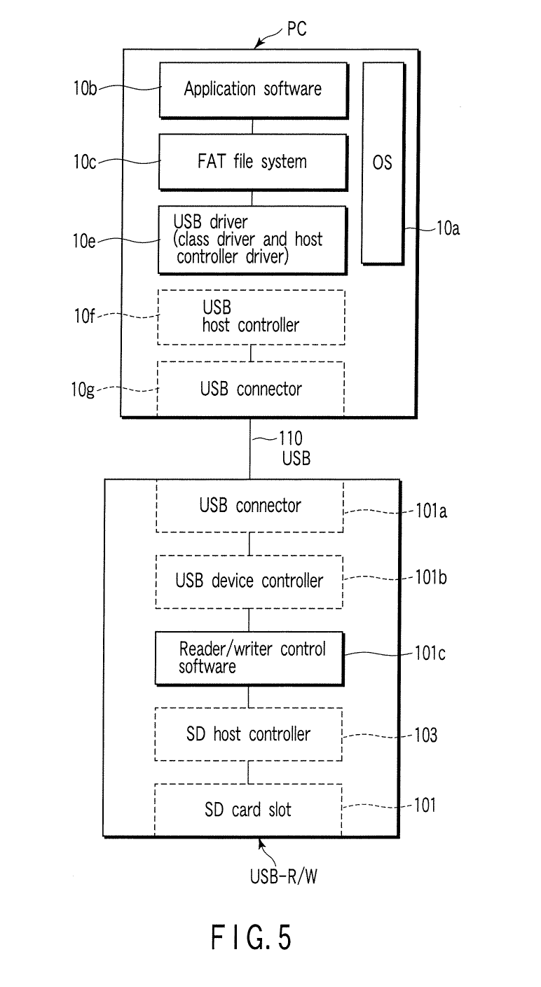

FIG. 5 shows a software structure in the system configured as shown in FIG. 1. As shown in FIG. 5, the personal computer PC is provided not only with the operating system (OS) 10a but also with the application software 10b, the FAT file system 10c, a USB driver (class driver or host controller driver) 10e, a USB host controller 10f, a USB connector 10g, and the like. In the present embodiment, the application software 10b is the top-level software, followed by the FAT file system 10c, followed by the USB driver 10e. The USB host controller 10f is connected to the USB driver 10e. The USB connector 10g is connected to the USB host controller 10f. One end of USB 110 is connected to the USB connector 10g.

On the other hand, the SD card reader/writer USB-R/W is provided with a USB connector 101a, a USB device controller 101b, reader/writer control software (driver) 101c that is firmware for the SD card reader/writer USB-R/W, the SD host controller 103, the SD card slot 101, and the like. The other end of USB 110 and the USB device controller 101b are connected to the USB connector 101a. The reader/writer control software 101c is connected to the USB device controller 101b. The SD host controller 103 is connected to the reader/writer control software 101c. The SD card slot 101 (that is, the card detection switch 102 and the plurality of connection electrodes 101a) is connected to the SD host controller 103.

Now, with reference to FIG. 5, description will be given of file access of the application software 10b in the personal computer PC to the media (miniSD card or microSD card) 31.

First, the miniSD card or microSD card is installed in the SD card adaptor 21. The SD card adaptor 21 containing the miniSD card or microSD card is inserted into the SD card slot 101 of the SD card reader/writer USB-R/W. Then, the card detection switch 102 detects the insertion of the SD card or the SD card adaptor 21. This information is transmitted via the SD host controller 13 to the reader/writer control software 101c, which then transmits it to the personal computer PC via the USB device controller 101b, USB connector 101a, and USB 110.

The information sent to the personal computer PC is transmitted to the FAT file system 10c via the USB connector 10g, USB host controller 10f, and USB driver 10e. In this case, a status (state information) indicating “Media Changed” is internally generated. The application software 10b checks the status to recognize that the media 31 has been changed.

The application software 10b in the personal computer PC subsequently gives an instruction for a file access. The FAT file system 10c transmits the instruction to the SD card reader/writer USB-R/W via the USB driver 10e, USB host controller 10f, USB connector 10g, and USB 110. The SD card reader/writer USB-R/W controls the firmware so that file management information is loaded from the miniSD card or microSD card. That is, firmware in the SD card reader/writer USB-R/W accesses the miniSD card or microSD card to read, for example, data from the FAT area or directory entry to obtain file management information. The SD host controller 103 then stores the read file management information in RAM 107 via the system 105. In addition to acquiring the file management information, a predetermined initialization process (described later in detail) is executed when, for example, the media is changed after power-on.

In this state, it is assumed that the application software 10 in the personal computer PC gives an instruction for a file access to the FAT file system 10c. The FAT file system 10c then also controls the firmware in the SD card reader/writer USB-R/W and references the file management information stored in RAM 17 to allow the firmware to execute a file access on the miniSD card or microSD card.

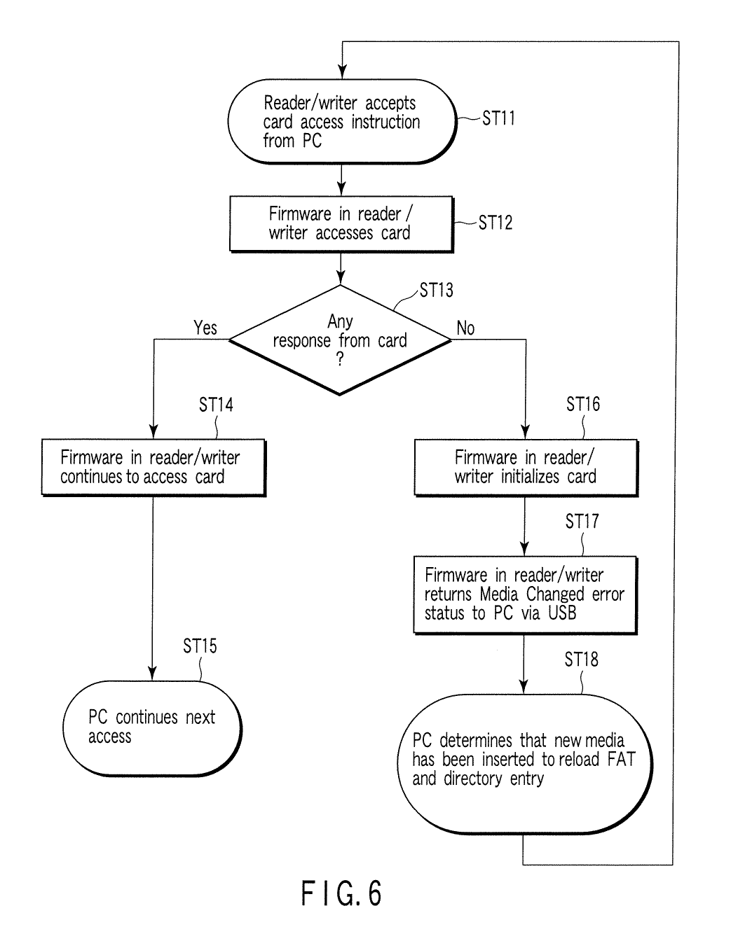

FIG. 6 shows the operation (process flow) of the SD card reader/writer USB-R/W during a file access to the miniSD card or microSD card. It is assumed that the firmware in the SD card reader/writer USB-R/W accepts an instruction for a file access from the application software in the personal computer PC (step ST11). The firmware in the SD card reader/writer USB-R/W then issues an access command to the miniSD card or microSD card via the SD host controller 103 (step ST12).

If the miniSD card or microSD card has not been changed, a normal response to the access command is returned by the miniSD card or microSD card (step ST13). The normal response is also returned when the SD card or the SD card adaptor 21 has been regularly removed and inserted. Thus, upon receiving the normal response, the firmware in the SD card reader/writer USB-R/W continues the access process on the miniSD card or microSD card (step ST14). The application software 10b in the personal computer PC is subsequently notified of end of the access process (step ST15). The application software 10b then enters a standby state to get ready to give an instruction for the next file access.

In step ST13, if the firmware in the SD card reader/writer USB-R/W does not receive the normal response from the miniSD card or microSD card, it determines that the miniSD card or microSD card needs to be initialized. The firmware thus performs a predetermined initialization process (step ST16). This initialization process is initial processing enabling accesses to the card, for example, setting of parameters for determining a bus interface.

If the miniSD card or microSD card is removed and inserted with the SD card adaptor 21 remaining inserted in the SD card slot 11, the card detection switch 12 is not activated. Thus, the newly installed miniSD card or microSD card has not been subjected to the initialization process otherwise executed after power-on (when the media is changed). Consequently, the miniSD card or microSD card does not return the normal response to the access command from the SD card reader/writer USB-R/W. Thus, the firmware forcibly performs the initialization process on the miniSD card or microSD card that does not make the normal response so that the firmware can access the miniSD card or microSD card.

The firmware in the SD card reader/writer USB-R/W also returns the status “Media Changed”, indicating that the media 31 has been changed, via USB 10 to the FAT file system 10c and application software 10b, which are at a higher level of the personal computer PC (step ST17). This enables the application software 10b in the personal computer PC to recognize that the miniSD card or microSD card has been changed even though the card detection switch 12 is not activated. The firmware in the SD card reader/writer USB-R/W further accesses the newly installed miniSD card or microSD card in accordance with an instruction from the FAT file system 10c to read, for example, data from the FAT area and directory entry to obtain file management information. The SD host controller 103 then stores the read file management information in RAM 107 via the system bus 105 (step ST18).

It is assumed that the firmware in the SD card reader/writer USB-R/W subsequently accepts an instruction for a file access from the application software 10d via the FAT file system 10c, USB 110, and the like again (step ST11). Then, in steps ST12, ST13, and ST14, on the basis of the file management information re-stored in RAM 17, the firmware in the SD card reader/writer USB-R/W executes a file access process on the newly installed miniSD card or microSD card.

As described above, upon determining that the miniSD card or microSD card needs to be initialized, the SD card reader/writer, connected to the personal computer, also executes an initialization process. The SD card reader/writer also notifies the higher-level software or host equipment of the media change. Thus, even if the user carelessly removes and inserts the miniSD card or microSD card directly from and into the SD card adaptor, the file format can be prevented from being inconsistent. Therefore, the convenience of the miniSD card and microSD card can be improved, for example, the newly installed media 31 can be properly accessed in spite of a failure to detect the change of the media 31.

The above embodiments have both been described taking the case of the SD card, miniSD card, and microSD card. However, the present invention is not limited to this. The present invention is applicable to other memory card and devices, for example, provided that they are set in the adaptor when inserted into the slot.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a card slot into which a nonvolatile memory card is inserted; and
a device driver software having a function which accesses the nonvolatile memory card inserted into the card slot, the device driver software, upon determining that the nonvolatile memory card needs to be initialized, initializing the nonvolatile memory card and generating state information indicating that the nonvolatile memory card has been newly inserted.

2. The information processing apparatus according to claim 1, wherein the nonvolatile memory card includes a first nonvolatile memory card which is inserted into the card slot via an adaptor and a second nonvolatile memory card which is inserted directly into the card slot, and
the adaptor comprises the same interface as that of the second nonvolatile memory card to enable the device driver software to access the first nonvolatile memory card.

3. The information processing apparatus according to claim 2, wherein the adaptor allows the first nonvolatile memory card to be freely changed.

4. The information processing apparatus according to claim 1, wherein the card slot and the device driver software are provided in a personal computer, and the device driver software notifies software controlling the personal computer of the state information.

5. The information processing apparatus according to claim 1, wherein the card slot and the device driver software are provided in a card reader/writer connected to a personal computer, and the device driver software notifies software controlling the personal computer of the state information.

6. The information processing apparatus according to claim 1, wherein the device driver software determines whether or not to initialize the nonvolatile memory card, in response to access to the nonvolatile memory card.

7. The information processing apparatus according to claim 1, wherein if the device driver software does not receive a normal response to an access command from the nonvolatile memory card, the device driver software determines that the nonvolatile memory card needs to be initialized.

8. The information processing apparatus according to claim 1, wherein if the device driver software has initialized the nonvolatile memory card, the device driver software loads file management information from the nonvolatile memory card and then resumes an access to the nonvolatile memory card.

9. An information processing apparatus comprising:
a card slot into which a nonvolatile memory card is inserted;
a detection switch which detects insertion of the nonvolatile memory card into the card slot;
software which recognizes that the nonvolatile memory card has been newly inserted on the basis of state information corresponding to an output from the detection switch; and
a driver having a function which accesses the nonvolatile memory card inserted into the card slot, the driver generating the state information on the basis of the output from the detection switch;
wherein if the driver accesses the nonvolatile memory card to determine that the nonvolatile memory card needs to be initialized, the driver initializes the nonvolatile memory card.

10. The information processing apparatus according to claim 9, wherein the nonvolatile memory card includes a first nonvolatile memory card which is inserted into the card slot via an adaptor and a second nonvolatile memory card which is inserted directly into the card slot, and
the adaptor comprises the same interface as that of the second nonvolatile memory card to enable the driver to access the first nonvolatile memory card.

11. The information processing apparatus according to claim 10, wherein the adaptor allows the first nonvolatile memory card to be freely changed.

12. The information processing apparatus according to claim 9, wherein the card slot, the detection switch, the software, and the driver are provided in a personal computer.

13. The information processing apparatus according to claim 9, wherein the card slot, the detection switch, and the driver are provided in a card reader/writer connected to a personal computer, and the software is provided in the personal computer.

14. The information processing apparatus according to claim 9, wherein the driver determines whether or not to initialize the nonvolatile memory card, in response to access to the nonvolatile memory card.

15. The information processing apparatus according to claim 9, wherein if the driver does not receive a normal response to an access command from the nonvolatile memory card, the driver determines that the nonvolatile memory card needs to be initialized.

16. A card reader/writer comprising:
a card slot into which a nonvolatile memory card is inserted; and
a controller having a function which accesses the nonvolatile memory card inserted into the card slot,
wherein if the controller determines that the nonvolatile memory card needs to be initialized, the card reader/writer initializes the nonvolatile memory card, generates state information indicating that the nonvolatile memory card has been newly inserted, and notifies an information processing apparatus connected to the card reader/writer of the state information.

17. The card reader/writer according to claim 16, wherein if the card reader/writer does not receive a normal response to an access command from the nonvolatile memory card, the card reader/writer determines that the nonvolatile memory card needs to be initialized.

18. The card reader/writer according to claim 16, wherein the nonvolatile memory card is inserted into the card slot via an adaptor.
